(19) United States
(12) Patent Application Publication
(10) Pub. No.: US 2018/0141297 A1
(43) Pub. Date: May 24, 2018

(54) Crimping Machine

(71) Applicant: Ingemat, S.L., Zamudio (Vizcaya) (ES)

(72) Inventors: Juan José Alaña Gómez, Zamudio (Vizcaya) (ES); Gaspar Moreno García, Zamudio (Vizcaya) (ES); Jesús Bahillo de la Puebla, Zamudio (Vizcaya) (ES)

(21) Appl. No.: 15/524,506

(22) PCT Filed: Oct. 29, 2015
(86) PCT No.: PCT/ES2015/070777

§ 371 Date: May 4, 2017

(30) Foreign Application Priority Data
Nov. 5, 2014 (ES) P201431621

(51) Int. Cl. B30B 9/28; B30B 15/04; B30B 1/18

(52) U.S. Cl. CPC B30B 9/28; B21D 39/021; B30B 1/18; B30B 15/04

(57) ABSTRACT

The invention relates to a crimping machine comprising a moveable carriage that can move linearly in two directions and is guided in a stationary carriage, wherein the moveable carriage moves by means of a leadscrew-nut mechanism which is actuated by a gear motor secured to the moveable carriage. A tilting head is coupled to the moveable carriage, the tilting head having pre-crimping blades and other crimping blades secured thereto for the purpose of bending tabs disposed on the perimeter edges of a part to be crimped. The leadscrew is a non-rotating, non-moving stationary element that is secured by one end to an upper base of the stationary carriage, while the nut of the leadscrew-nut mechanism has combined rotational and translational motion with respect to the leadscrew, wherein the rotation of the nut pulls the moveable carriage along, moving same in one direction or the other, depending on the direction of rotation of said nut.

### OBJECT OF THE INVENTION

As expressed in the title of this description, the present invention refers to a crimping machine for clamping body parts by crimping tabs that are an integral part of the body parts themselves.

The object of the invention is enhancing the overall design of the crimping machine by reducing its size and thus improving the job of the operators.

### BACKGROUND OF THE INVENTION

Clamping or crimping machines are used in the automotive industry for clamping body parts and are designed to combine two movements: on the one hand, a two-direction lifting/descending displacement and, on the other, a rotation movement. Thus, a pair of blades, one for pre-crimping and the other for crimping, are located at the end of the machine and may conduct the continuous bending operations of the body parts.

The lifting/descending movement is applied to a moveable carriage guided in a stationary carriage, whereas the rotation movement is applied to a tilting head coupled to the moveable carriage.

Said lifting/descending movement is carried out by means of a motor connected to a first pulley that is linked to a second pulley through a toothed belt, where the second pulley is rigidly attached to a lifting and descending leadscrew. The output of the motor shaft undergoes a first speed reduction by means of a reducer coupled to said shaft, and a second speed reduction by means of this mechanism of two pulleys and toothed belt.

Bending operations are usually carried out in two stages, although sometimes three stages are necessary.

Initially, the part to be clamped has an open tab throughout the outline, creating an angle, generally variable, usually within a 90-degree range (although it may be significantly wider or narrower).

The work is carried out by placing the part to be clamped on a cradle that mimics in an exact way the volume of the final part to be obtained, and subsequently proceeding with the crimping by continuously approaching and descending the pre-crimping blade and, later, the crimping blade.

In the first stage, the result is a tab throughout the outline of the part to be clamped, with an angle of about 45° and, in the second stage, the result is the bending of the fully crimped tab.

The lifting mechanism of the moveable carriage comprises a rotating leadscrew coupled to a nut that is rigidly attached to the structure of the stationary carriage, highlighting the fact that the leadscrew belongs to the moveable carriage.

Given this situation, the machine dimensions are based on the length of the leadscrew and of the stroke thereof. This is due to the fact that the leadscrew displaces throughout its length towards both sides of the nut, thus needing this space in the structure of the stationary carriage of the machine.

Since the stationary carriage of the machine is where the table to place the part to be clamped is located, the dimensions of current stationary carriages require the use of stairs or ladders to access the upper side of the stationary carriage, leading to safety-related problems for the operators when they conduct maintenance tasks, both on the table and on the blades.

### DESCRIPTION OF THE INVENTION

In order to meet the objectives and avoid the drawbacks mentioned in the previous sections, the invention proposes a crimping machine that comprises a moveable carriage that can move linearly in two directions, which is guided in a stationary carriage.

The moveable carriage moves through a leadscrew-nut mechanism actuated by a gear motor secured to the moveable carriage; the moveable carriage having a tilting head coupled thereto, where pre-crimping blades and crimping blades are secured to bend tabs disposed on perimeter edges of a piece to be clamped, being fully integral thereto.

The leadscrew of the leadscrew-nut mechanism is a non-rotating, non-moving stationary element that is secured by one end to an upper base that is an integral part of the stationary carriage.

The securement of the leadscrew to the upper base of the stationary carriage comprises a mounting structure formed by:
an upper fastening part attached to the upper base of the stationary carriage.
a lower fastening part.
a locking part that attaches both fastening parts by means of an anchoring screw threading on an orifice that affects both fastening pieces: upper and lower.

These two fastening parts are linked to each other by means of a tongue-and groove coupling in dovetail shape; where the relative position therebetweeen is secured by means of a dowel pin, fitted in a perforation affecting both fastening parts: upper and lower.

The upper fastening part has a dovetail-shaped female configuration, whereas the lower fastening part has a dovetail-shaped male configuration.

The locking part has a dovetail-shaped female configuration, which adapts to a lateral side of the dovetail-shaped male configuration of the lower fastening part when the locking part is immobilised by the anchoring screw.

An upper end section of the leadscrew is secured to the lower fastening part by means of a securing nut, which has an anti-rotation system supplementing said upper end section of the leadscrew. Therefore, the leadscrew is always located in the same position, thus preventing the loss of accuracy during the movement of the moveable carriage.

The nut of the leadscrew-nut mechanism has a combined rotational and translational motion with respect to the leadscrew, where the rotation of the nut pulls the moveable carriage along, moving it in one direction or the other, depending on the direction of rotation of said nut.

In addition, the nut of the leadscrew-nut mechanism is linked to the moveable carriage by means of a bearing housing that is rigidly secured to said moveable carriage, whereas the leadscrew is rigidly attached through one of its ends to the stationary carriage.

The bearing housing comprises:
an inner bushing rigidly secured around the nut.
an outer carcass embedded in a casing of the moveable carriage.
bearings fitted within an intermediate annular space defined between the inner bushing and the outer carcass; wherein the rotation of the nut transmits its rotation to the inner bushing of the bearing housing, but not to the outer carcass rigidly attached to the moveable carriage.

The inner bushing is secured to the nut of the leadscrew-nut mechanism by means of an embedded coupling.

The transmission of movement to the nut of the leadscrew-nut mechanism comprises a lead pulley embedded in an output shaft of the gear motor, a follower pulley associated to the nut of the leadscrew-nut mechanism, and a transmission belt coupled to both pulleys: lead and follower pulley.

It is worth noting that said follower pulley is embedded in the inner bushing of the bearing housing.

The crimping machine includes a lubrication system comprising a blind longitudinal perforation made on the leadscrew, in combination with a lower radial perforation that leads to the threaded surface of the leadscrew, and upper radial perforations also made in the leadscrew, which converge in the longitudinal perforation of the leadscrew; wherein said radial perforations lead to an annular channel located in the lower fastening part, communicating with said annular channel a supply orifice of the lubricant integrated in the lower fastening part.

With this configuration, a crimping machine of reduced dimensions is achieved, which facilitates the tasks of the operators and does not require the use of stairs or ladders to access the table or the blades and to conduct maintenance tasks. Hereinafter, in order to give a better understanding of this description, the object of the invention has been detailed in a series of drawings that are an integral part of the report and are for illustration purposes and without limitation.

### BRIEF DESCRIPTION OF THE DRAWINGS

FIG. 1 shows a perspective view of the crimping machine, which is the object of the invention.

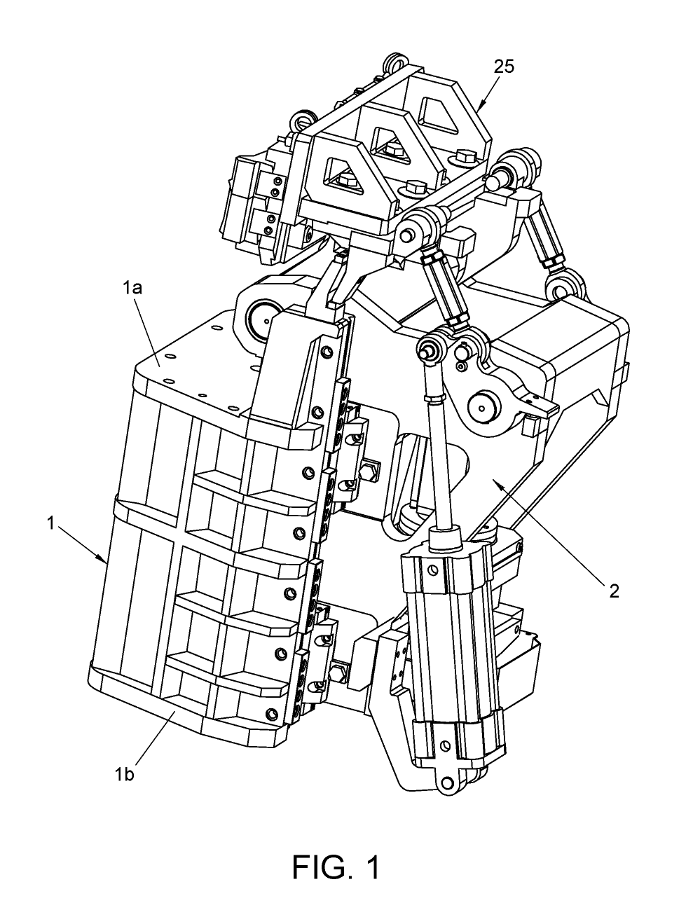

FIG. 2 shows a cross-sectional elevation view of the crimping machine.

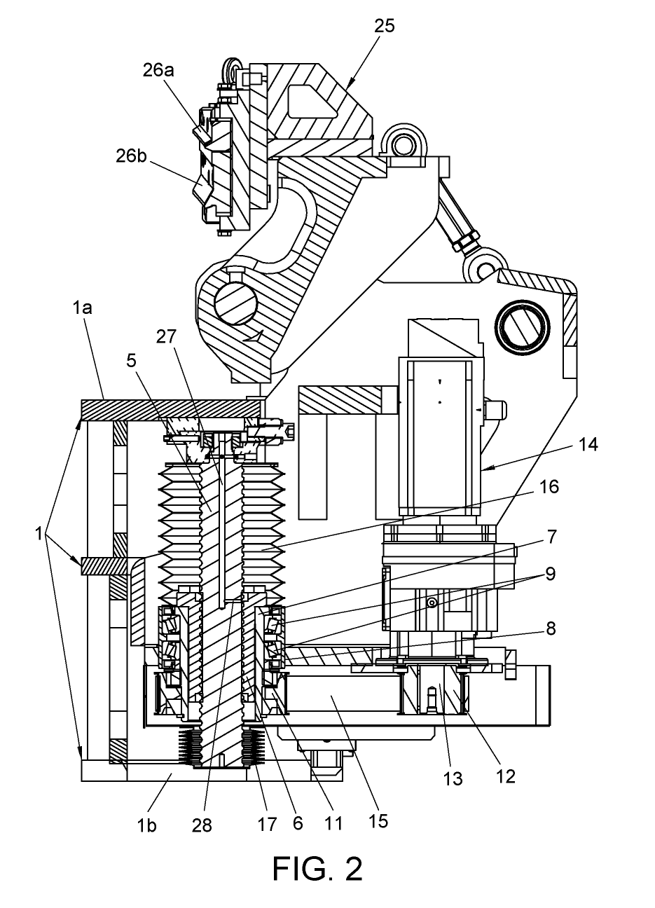

FIG. 3 shows a cross-sectional plane view of the machine of the invention.

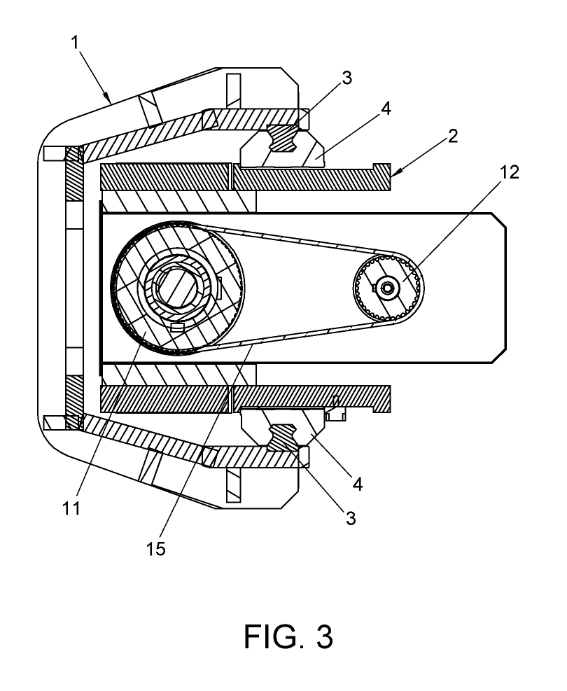

FIG. 4 shows a cross-sectional view of a side of the moveable carriage.

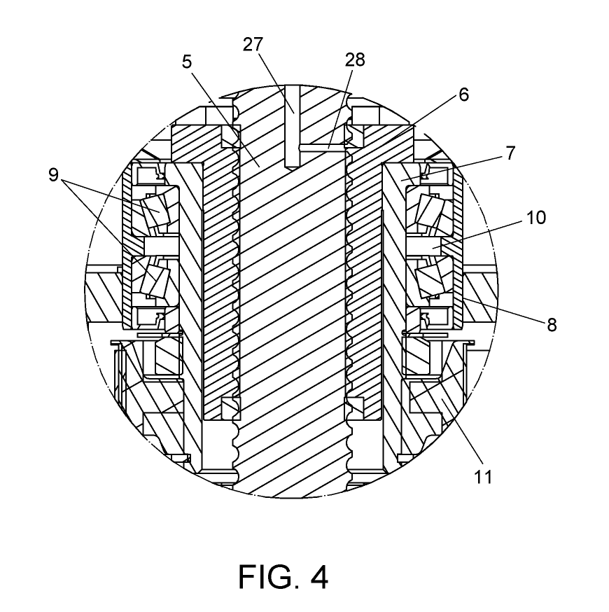

FIG. 5 shows a cross-sectional view of an upper side of the leadscrew, where a characteristic lubricant system of the connection between the nut and the leadscrew is highlighted.

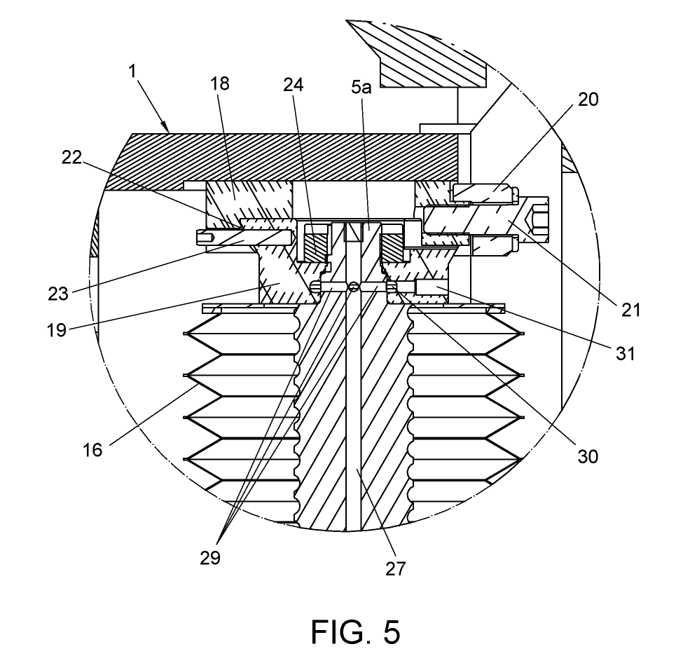

### DESCRIPTION OF A SAMPLE EMBODIMENT OF THE INVENTION

Taking into account the numbering adopted in the figures, the crimping machine comprises a stationary carriage (1) and a moveable carriage (2) that can move linearly in both directions, where said linear movement of the moveable carriage (2) is ensured by means of a coupling formed by skids (3) in combination with guides (4).

The moveable carriage (2) moves by means of a leadscrew (5)-nut (6) mechanism, where the leadscrew (5) is a non-rotating, non-moving stationary element where the nut (6) is coupled, which has a combined rotational and translational movement with respect to the leadscrew (5), such that when the rotation of the nut (6) is actuated, the nut pulls the moveable carriage (2) along. The nut (6) is linked to the moveable carriage (2) by means of a bearing housing that is rigidly secured to said moveable carriage (2), whereas the leadscrew (5) is rigidly attached through one of its ends to the stationary carriage (1).

The above-mentioned bearing housing comprises an inner bushing (7) rigidly secured around the nut (6), an outer carcass (8) embedded in a casing of the moveable carriage (2), and bearings (9) within an intermediate annular space (10) defined between the inner bushing (7) and the outer carcass (8), such that when the nut (6) rotates, it transmits its rotation to the inner bushing (7) of the bearing housing, but not to the outer carcass (8) rigidly attached to the moveable carriage (2), due to the interposition of the bearings (9).

The inner bushing (7) of the bearing housing is secured to the nut (6) by means of an embedded coupling.

In a lower part of the above-mentioned inner bushing (7) that protrudes from underneath the bearings (9), a follower pulley (11) is secured, which supplements with other lead pulley (12) secured to an output shaft (13) of a gear motor (14) attached to the moveable carriage (2) itself, thus transmitting the movement between both pulleys, lead (12) and follower (11), by means of a belt (15).

With the described arrangement, when the gear motor (14) is actuated, its rotational movement is transmitted to the nut (6) of the leadscrew (5)-nut (6) mechanism, the nut thus pulling the moveable carriage (2) in one direction or the other depending on the rotational direction of the gear motor (14); all of this thanks to the rigid connection between the bearing housing and the moveable carriage (2).

The leadscrew (5) is secured through an end to an upper base (1a), whereas the opposite end of said leadscrew (5) faces a lower base (1b) without connecting thereto, where both bases (1a) and (1b) are an integral part of the stationary carriage (1), such that a section of the leadscrew (5) located in the upper side of the bearing housing is protected by an upper bellow (16), whereas a section of the leadscrew (5) located in the lower side of the bearing housing is protected by a lower bellow (17).

The securement of the leadscrew (5) to the upper base (1a) of the stationary carriage (1) is realised by means of a mounting structure formed by an upper fastening part (18) attached to the upper base (1a) of the stationary carriage (1), a lower fastening part (19), and a locking part (20) that attaches both fastening parts (18), (19) by means of an anchoring screw (21), threading on an orifice that affects both fastening parts: upper (18) and lower (19).

These two fastening parts (18), (19) are linked to each other by means of a tongue-and-groove coupling (22) in dovetail shape, ensuring the relative position therebetweeen by means of a dowel pin (23), fitted in a perforation that affects both fastening parts: upper (18) and lower (19). The upper fastening part (18) has a dovetail-shaped female configuration whereas the lower fastening part (19) has a dovetail-shaped male configuration.

The locking part (20) has a dovetail-shaped female configuration which adapts to a lateral side of the dovetail-shaped male configuration of the lower fastening part (19) when the locking part (20) is immobilised by the anchoring screw (21). The leadscrew (5) has an upper end section (5a) that is secured to the lower fastening part (19) by employing a securing nut (24), which has an anti-rotation system that supplements said upper end section (5a) of the leadscrew (5), such that the leadscrew (5) is always located in the same position, thus, preventing the loss of accuracy during the movement of the moveable carriage (2).

It is worth noting that the leadscrew (5) and its position in the crimping machine is a key factor for the accuracy required for this type of machines.

The system envisaged for mounting and dismounting the leadscrew (5) by means of the described mounting structure allows said operations to be carried out in a fast and simple way, guaranteeing the exact position.

The leadscrew (5) is secured to the stationary carriage (1) through its upper side. In addition, since said upper side of the stationary carriage (1) is the location of a cradle where the parts to be clamped or crimped are placed, a fast and comfortable access has been created by means of the mounting structure described, to ensure a correct maintenance of the leadscrew (5).

On the other hand, a tilting head (25) is coupled in an end of the moveable carriage (2), where pre-crimping blades (26a) and crimping blades (26a) are secured to conduct the bending of tabs disposed around the part to be clamped, forming an integral part thereof.

The crimping machine also incorporates a lubrication system to lubricate the threaded coupling between the leadscrew (5) and nut (6).

Said lubrication system comprises a blind longitudinal perforation (27) made in the leadscrew (5), in combination with a lower radial perforation (28) that leads to a threaded surface of the leadscrew (5), and upper radial perforations (29) also made in the leadscrew (5), which converge in the blind longitudinal perforation (27) of the leadscrew (5), such that said upper radial perforations (29) lead to an annular channel (30) made in the lower fastening part (19), a supply orifice (31) of the lubricant, through which the lubricant is introduced, communicating with said annular channel (30).

Therefore, when the lubricant is injected through the supply orifice (31) integrated in the lower fastening part (19), the lubricant runs through the annular channel (30), the upper radial orifices (29), the blind longitudinal perforation (27), and the lower radial perforation (28), leading to the threaded surface of the leadscrew (5).

1. A crimping machine, comprising a moveable carriage that can move linearly in two directions, which is guided in a stationary carriage; where the moveable carriage moves by leadscrew-nut mechanism which is actuated by a gear motor secured to the moveable carriage; the movable carriage having a tilting head coupled thereto, where pre-crimping blades and crimping blades are secured to conduct the bending of tabs disposed in perimeter edges of the part to be crimped; wherein,
the leadscrew of the leadscrew-nut mechanism is a non-rotating, non-moving stationary element secured by one of its ends to an upper base that is an integral part of the stationary carriage; and
the nut of the leadscrew-nut mechanism has a combined rotational and translational movement with respect to the leadscrew, where the rotation of the nut pulls the moveable carriage along, moving it in one direction or the other, depending on the direction of rotation of said nut.

2. The crimping machine according to claim 1, wherein the nut of the leadscrew-nut mechanism is linked to the moveable carriage by means of a bearing housing, which is rigidly secured to said moveable carriage, whereas the leadscrew is rigidly attached through one of its ends to the stationary carriage.

3. The crimping machine according to claim 2, wherein the bearing housing comprises:
an inner bushing rigidly secured around the nut;
an outer carcass embedded in a casing of the moveable carriage;
bearings fitted within an intermediate annular space defined between the inner bushing and the outer carcass; where the rotation of the nut transmits its rotation to the inner bushing of the bearing housing, but not to the outer carcass rigidly attached to the moveable carriage.

4. The crimping machine according to claim 3, wherein the inner bushing is secured to the nut by an embedded coupling.

5. The crimping machine according to claim 1, wherein the transmission of movement to the nut of the leadscrew-nut mechanism comprises a lead pulley embedded in an output shaft of the gear motor, a follower pulley associated to the nut of the leadscrew-nut mechanism, and a transmission belt coupled to both pulleys: lead and follower.

6. The crimping machine according to claim 3, wherein the follower pulley is embedded in an annular extension of the inner bushing of the bearing housing.

7. The crimping machine according to claim 1, wherein the securement of the leadscrew to the upper base of the stationary carriage comprises a mounting structure formed by:
an upper fastening part attached to the upper base of the stationary carriage;
a lower fastening part;
a locking part that attaches both fastening parts, by an anchoring screw, threading on an orifice that affects the upper fastening part and the lower fastening part,
wherein the upper fastening part and the lower fastening part, are linked to each other by a tongue-and-groove coupling in dovetail shape; where the relative position therebetweeen is secured by means of a dowel pin, fitted in a perforation affecting both of the upper fastening part and the lower fastening part wherein the upper fastening part has a dovetail-shaped female configuration, and wherein the lower fastening part has a dovetail-shaped male configuration.

8. The crimping machine according to claim 7, wherein the locking part has a dovetail-shaped female configuration which adapts to a lateral side of the dovetail-shaped male configuration of the lower fastening part when the locking part is immobilised by the anchoring screw.

9. The crimping machine according to claim 7, wherein an upper end section of the leadscrew is secured to the lower fastening part by a securing nut, which has an anti-rotation system that supplements said upper end section of the leadscrew.

10. The crimping machine according to claim 7, further comprising a lubrication system that comprises a blind longitudinal perforation integrated in the leadscrew, in combination with a lower radial perforation that leads to the threaded surface of the leadscrew, and upper radial perforations also integrated in the leadscrew, which converge in the longitudinal perforation of the leadscrew; wherein said radial perforations lead to an annular channel located in the lower fastening part, a supply orifice of the lubricant, integrated in the lower fastening part, communicating with said annular channel.
